(19) United States
(12) Patent Application Publication
(10) Pub. No.: US 2012/0188780 A1
(43) Pub. Date: Jul. 26, 2012

(54) Led lamp

(76) Inventor: Sylwester D. Wilk, Yonkers, NY (US)

(21) Appl. No.: 13/136,707

(22) Filed: Aug. 8, 2011

Related U.S. Application Data
(60) Provisional application No. 61/413,420, filed on Nov. 13, 2010.

(51) Int. Cl. F21L 4/08; F21V 13/04; B60Q 1/00; F21V 29/00; F21V 7/00; F21L 4/00

(52) U.S. Cl. 362/509; 362/235; 362/191; 362/183

(57) ABSTRACT

LED lamp structures and lighting fixtures are provided, particularly “down” or recessed lighting fixtures, street lamp fixtures, “work-lights” and automobile headlights. A fan and a heat sink are provided with each lamp and the LED array is attached directly to the heat sink. The fans used preferably are computer cooling fans which are particularly small, efficient and inexpensive. The fans preferably force air through the fins sideways. The fans in some embodiments are recessed among the fins of the heat-sink so as to conserve space and obtain direct flow of air through the fins. The low-volume exhaust from the fans is released directly into the air space or housing in which the lamps are mounted without the need for special ducting, thus taking advantages of the naturally-occurring crevices and opening for all or part of air escape openings.

This invention relates to LED lamps, and particularly to relatively high power lamps with cooling means for the LED light-producing elements. Priority is claimed from Provisional Patent Application Ser. No. 61/413,420 filed Nov. 13, 2010, and U.S. patent application Ser. No. 12/931,540, filed Feb. 2, 2011. The disclosures of those applications hereby are incorporated herein by references.

LED lamps are becoming more popular because they are much more efficient than incandescent or fluorescent lighting, and therefore require much less energy, but also because the LED lamp normally lasts thousands of hours, under normal use, without requiring replacement.

One continuous problem is the initial cost of such lamps. Even though the lamps may be more economical to use, when their purchase price is amortized over the very long life of the lamps, the relatively high initial cost is a deterrent to the purchase and use of such lamps.

A further problem with such lamps is that when LED lamps of relatively high wattage, such as 20 Watts to 100 Watts are used, the LED lamp arrays (the light-producing elements) usually need cooling. Therefore, in some prior LED lamps, relatively expensive, high-throughput fans and ductwork often have been proposed for use in cooling the LED lamp arrays. This equipment not only is relatively expensive, but it also is bulky so that it is relatively difficult to fit the lamps into cramped spaces.

A particular problem exists with recessed lighting or so-called “down lamps.” The fact that the lamps are recessed in the ceiling of a room confines the lamp to fairly cramped quarters and makes the handling and installation of the units relatively difficult and expensive.

Similar problems are suffered by outdoor lighting fixtures such as street lamps. Certain lamps are known as “work lights” or “work lamps.” These are lamps used, typically, by painters, plumbers, construction workers, home owners, etc., to light indoor and outdoor building and other work sites. Typically, such lamps use incandescent, fluorescent, halogen or LED light sources.

Halogen work lamps emit high intensity light, but they can get very hot during use and therefore usually use heavy wire shields over the outlet light window to prevent burns. Also, the bulbs burn out relatively quickly so that spares usually are kept on hand, and the cost of replacing bulbs can be significant.

LED work lamps are available, but usually are relatively expensive and are limited in output light intensity.

Similar problems exist with LED automobile headlights; that is, existing LED headlamps usually have limited light output, and are overly expensive.

Therefore, it is an object of the present invention to provide LED lamp structures which remedy or alleviate the foregoing problems.

More particularly, it is an object to provide an LED lamp structure which is relatively inexpensive, compact, and easy to install.

It is a further object of the invention to provide such a lamp structure which eliminates the need for expensive ducting and other ancillary structures.

In accordance with the present invention, the foregoing objectives are met by the provision of a LED lamp fixture with a heat sink structure to which the LED array is attached directly, with a fan mounted nearby. Preferably, the heat sink has a central area without fins, and the fan is mounted in the central area of the heat sink structure so as to give the lamp a relatively low profile and make the lamp structure compact and relatively easy to fit into recessed spaces. The fan blades are shaped so as to push the air sideways through the spaces between the fins.

The fan/heat sink structure can be comparatively inexpensive and compact, in part because the preferred devices are those that have been produced in great quantities for use in computers. Not only are they relatively compact and inexpensive, but the applicant has found that such units are very efficient in cooling LED lamps, when they are correctly positioned.

The applicant has realized also that the fans can be mounted in recessed housings in buildings in the air spaces between the ceiling and the floor above it, and discharge the air flow directly into that air space, without use of expensive ducting. This is believed to be because the air flow rate is relatively low and the air escapes sufficiently rapidly through natural crevices and cracks in the building structure.

The applicant has applied the same principles in simplifying the construction of outdoor lighting appliances such as street lamps using LED lamps. Cooling fan air is exhausted directly into the housing of the lamp where it easily escapes through natural crevices in the lamp structure.

The same advantageous LED lamp structure is used to advantage in a work light or work lamp which is a portable lamp, with its own support structure, which is used to give bright illumination for professional painters, carpenters and other workers, as well as for non-professional workers. The lamp output usually can be tilted to shine upwardly from the floor or ground at a variable angle.

The lamp structure is used to further advantage in vehicle headlights such as automobile or truck headlights, to provide a reliable, low power-consumption, relatively low cost headlight package.

A back-up battery emergency power supply is provided as well. Because the LED lamp usually draws fewer watts of electrical energy for a given light output than many other lamps, the lamp of the invention can continue providing light for a substantial time after the normal power source has failed.

The great simplification of the air flow structures used in the invention is aided by the efficiency of the heat sink structures used in the invention, thereby minimizing the quantity of airflow required.

The foregoing and other objects and advantages of the invention will be set forth in or apparent from the following description and drawings.

### IN THE DRAWINGS

FIG. 1 is a perspective view of a lamp fixture embodiment of the present invention;

FIG. 2 is a cross-sectional view of the lamp fixture installed in a typical location, with a cross-sectional view of the lamp being taken along Line 2-2 of FIG. 1.

FIG. 3 is a cross-sectional view, like that of FIG. 2, of a different LED lamp fixture of the present invention;

FIG. 4 is a cross-sectional view taken along Line 4-4 of FIG. 3;

FIG. 5 is a perspective view of a heat sink and fan structure used in the lamp fixtures of FIGS. 1-4;

FIG. 6 is a cross-sectional view of another lamp fixture embodiment of the present invention;

FIG. 7 is a broken-away view take along Line 7-7 of FIG. 6; and

FIG. 8 is a top plan view of a component of the structure shown in FIG. 6.

FIG. 9 is a perspective view of a work light utilizing the invention;

FIG. 10 is a cross-sectional view, taken along line 10-10 of FIG. 9;

FIG. 11 is a rear elevation view, partially broken-away, showing a component of the FIG. 9 structure;

FIG. 12 is a perspective view of the invention used to advantage in an automobile headlight module;

FIG. 13 is a broken-away rear elevation view of the FIG. 12 structure;

FIGS. 14 and 15 are broken-away side elevation schematic and cross-sectional views of the structures in FIG. 12; and

FIGS. 16 and 17 are schematic circuit diagrams of battery back-up power supplies for the LED lamps of the invention.

### FLOODLIGHT FIXTURE

FIG. 1 shows a fixture 10 which is termed herein a “floodlight” fixture, in that it is of the type which normally receives an incandescent or other screw-in type bulb in a socket, and the bulb spreads light outwardly over a relatively wide area.

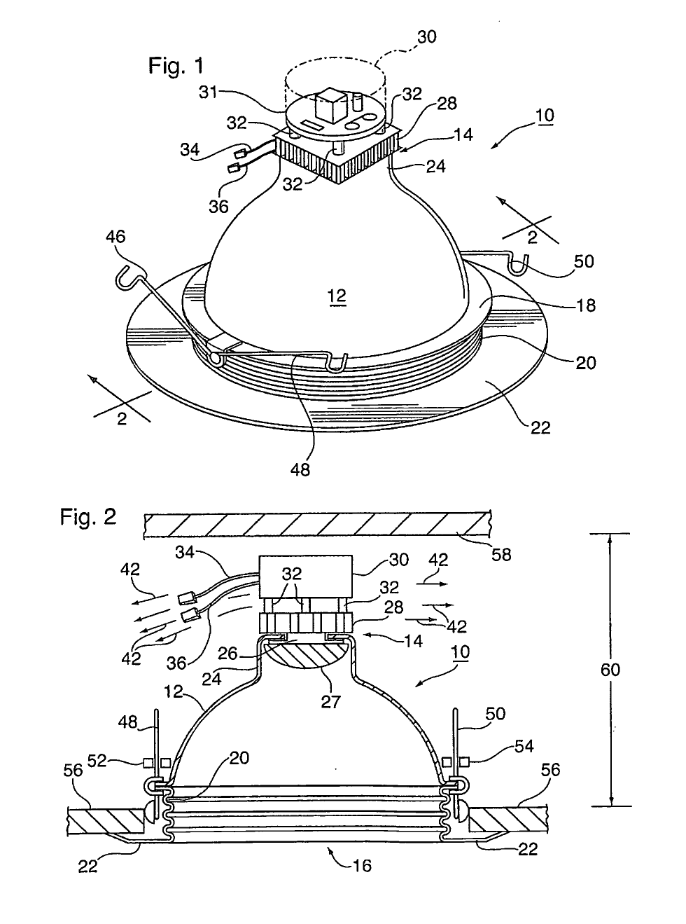

The fixture includes a bell-shaped housing 12 having an inlet opening at 14 and an outlet opening at 16 (FIG. 2) where light leaves the fixture.

The housing has a flange 22 with corrugated section 20 near its outlet end 16, and a relatively straight neck portion 24 leading to the inlet 14.

Instead of the usual incandescent lamp or other screw-in lamp, an LED array 26 is positioned at the inlet opening just inside the housing. The LED array 26 emits its light through a convex lens 27 which tends to spread the light outwardly. Alternatively, other lenses could be provided to shape the output light beam as desired.

Referring to FIG. 2, as well as FIG. 4, the LED array 26 has a central array 70 of LED light elements, in a package having flanges 64 and a body portion (behind the array 70 in FIG. 4). The body portion extends through the opening 14 and makes contact with the flat bottom of a heat sink 28. The LED array is attached to the flat bottom of the heat sink preferably by heat-conducting silicone thermal glue. Thus, the body of the LED array makes intimate, heat-conducting contact with the bottom of the metal heat sink.

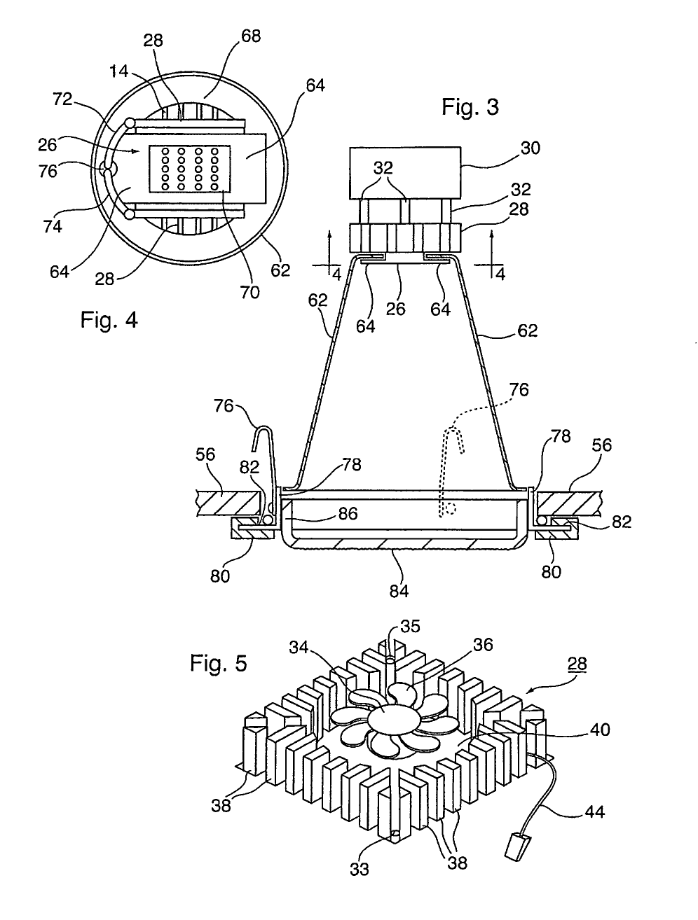

Referring to FIG. 2, as well as FIGS. 1 and 3, a power supply 30 is provided. It is mounted above and spaced from the upper surface of the heat sink 28 by screws and spacers 32 (not shown in FIG. 1). The power supply 30 may or may not have a cover such as that shown in FIGS. 2 and 3, and in dashed outline in FIG. 1.

Input leads 34 and 36 to the power supply are connected directly to the wiring of the building to supply the usual 120 Volts 60 Hz AC power. The power supply has a well-known construction. It typically uses a step-down transformer and a rectifier to convert AC voltage to 12 Volts DC for the fan motor, and 14 Volts DC for the LED array. Although separate power supplies can be provided for the two devices, a single power supply combining these functions is compact and relatively simple to mount and can be provided relatively inexpensively.

The preferred heat sink 28 and fan combination is shown in FIG. 5. The heat sink preferably is made out of aluminum or similar light-weight, inexpensive good heat-conducting material. The heat-sink has a hollowed-out body with a central cavity 40, and a plurality of fins 38. A fan 34 with blades 36 forces air out sideways between the fins to provide cooling.

The fan and heat sink combination shown in FIG. 5 is used for cooling VGA cards in computers. It is relatively inexpensive because it is manufactured in great quantities for use in computers around the world.

The fan 34 and heat-sink 28 combination is highly advantageous for use in the present invention in that its vertical height is quite small. This keeps the height of the structure above the inlet end of the lamp 12 housing relatively low. Thus, the fixture can be used in the space between the ceiling and floor in a building, as shown in FIG. 2, or in other cramped spaces without undue difficulty.

The power supply 30 preferably has a round, flat circuit board 31 (FIG. 1) on which the components are mounted. This board serves as a baffle for air flowing to or from the fan, so as to insure that the air will travel sideways as indicated in FIG. 2 by the arrows 42. This additionally gives some cooling, if needed, to the power supply.

It is preferred that the power supply has a thermistor which will open the power circuit to the LED lamp if and when it overheats due to failure of the fan, or a circuit like a light dimmer circuit which reduces the power delivered to the LED lamp when it overheats, usually by pulse-width modulation, until the lamp cools sufficiently.

Referring again to FIG. 5, the heat sink 28 has mounting holes 33 and 35, but other mounting holes can be provided as needed.

The power supply cord 44 to the fan 34 is connected into the power supply 30 through a connection which is not shown in the drawings.

Referring again to FIGS. 1 and 2, two pairs of spring arms, 46, 48, and 50 are provided on opposite sides of the housing 12. As it is well known, the spring arms are inserted into mounting receptacles, part of which are shown at 52, to retractably mount the fixture in the opening in the ceiling.

FIG. 2 shows the ceiling 56 and schematically shows the floorboards 58 of the floor above the ceiling 56. This provides an air space between the floorboards and the ceiling. That air space is indicated at 60 in FIG. 2.

In accordance with one highly advantageous feature of the invention, the air discharged from the fan is discharged sideways directly into the air space 60 without the use of ducting or other expensive construction features. This is due to the realization that the air need not be vented into the room below or elsewhere because it is easily able to escape through the normal crevices and openings in building construction air spaces.

Furthermore, it is an advantage of the invention that the fans that are selected are very low volume in their output because the heat-sink and fan arrangement is so efficient in carrying heat away from LED lamp arrays. Therefore, the output air volume is relatively low and can be essentially negligible.

### Shower Fixture

FIG. 3 shows a shower lamp fixture which is like that shown in FIG. 2, with certain exceptions. A frustro-conical housing 62 is provided with a glass outlet cover 82 with a rough pebbled outer surface 84 and a bezle 80. A rubber seal (not shown) is provided between the bezle and the ceiling 56 to make the fixture reasonably watertight so it can be used readily in showers or other wet areas.

Three convenient hook fasteners 76 (only two of which are shown) are provided for the easy mounting of the fixture in a ceiling mounting structure, as is well known. The bezle 80 is secured to the lower flange 82 of the housing 62.

In other respects, the function of the structure of the fixture in FIG. 3 is like the one shown in FIGS. 1 and 2.

### Outdoor Light Fixtures

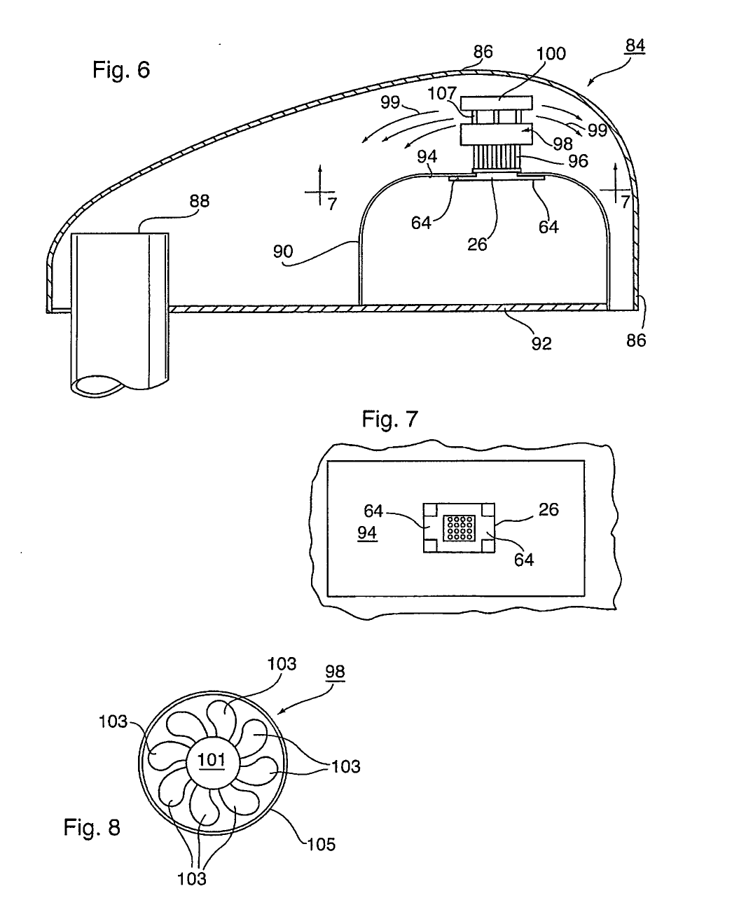

FIG. 6 is a cross-sectional view of a typical street lamp housing 86, which is mounted on a pole indicated schematically at 88, for street lighting purposes. Whereas the LED array used in the fixtures shown in FIGS. 1, 2 and 3 are relatively low power (e.g. 20 Watts to 50 Watts) which give illumination in the range of 60 Watt incandescent bulbs to 150 Watt incandescent bulbs, the street lighting fixture shown in FIG. 6 usually requires higher wattage for LED arrays, say 100 Watts or more. As a result, more cooling is required.

The LED array 26 is mounted in a reflector 90 within the housing 86 to reflect light from the LED lamp array outwardly through a window 92.

The fixture 84 shown in FIG. 6 has a single fan 98 in a circular housing mounted on top of a heat sink 96, and a power supply is mounted at 100 above the fan 98. The fan 98 draws air upwardly through the heat sink 96 and spreads it sideways in the directions of the arrows 99.

Because there is more room in the housing of lighting fixture 84 than for the fixtures in FIGS. 1-5, there is sufficient room for the more powerful but taller fan 98 and heat-sink 96 combination to be used.

FIG. 8 is a top plan view of the fan 98. It has a circular housing 105 with a fan motor 101 with blades 103 mounted within the housing 99. The housing and fan are mounted on the heat sink 96 by screws and spacers 107.

Preferably, this fan, like the fan 34 used in the fixtures shown in FIGS. 1-3 is used in cooling computers. Specifically, it is used to cool the CPU units in desk-top and other computers.

Alternatively, a fan and heat-sink combination like that in FIGS. 1-5 but with a higher output volume can be used, in order to keep the profile low.

Again, the air from the fan is simply discharged into the interior of the housing 86, from which it escapes easily through the small crevices and gaps occurring in such structures.

### Work Lights

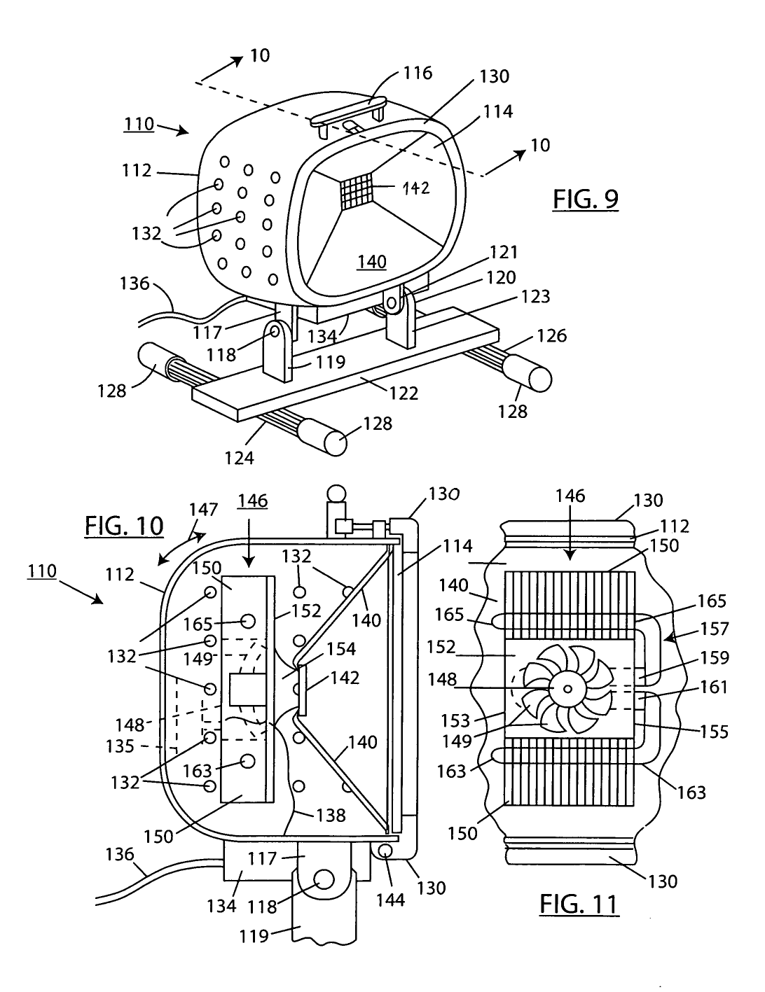

FIG. 9 is a perspective view of a work light or work lamp 110 provided in accordance with the invention.

As it is well known, work lights are used by painters, brick and tile layers, homeowners and others who need to have a well-lit work area, either indoors or outdoors, in which to perform their work.

Work lights are used indoors to light up dark rooms, or to light dark areas in basements or elsewhere to give adequate light to work by. Work lights also are used outdoors to illuminate work objects and areas, especially at night or on dark days.

The work light 110 includes a metal housing 112, a front glass window 114, a carrying handle 116 on top of the housing 112, and a support structure including mounting legs 117 and 121 extending downwardly from the housing 112, and support legs 119 and 123 coupled to the legs 117 and 121 by pivotable connections 118 and 120. The pivotable connections allow the work light housing 112 to be pivoted forward and backward, in the directions indicated by arrow 147 (FIG. 10), to tilt the light up or down, as needed. As it is well known, the tilt mechanism will hold the housing at the angle to which it is set.

The supports 119 and 123 are secured, as by bolts or welding, to a metal crossbar 122 which is secured to transverse support pipes 124 and 126 with rubber feet 128 to provide a stable support platform for the work light.

The work light 110 shown in FIG. 9 is relatively large work light of the size which normally uses a 500 watt halogen bulb to produce a great deal of output light power.

There are many other variations on the constructions of work lights, and the invention is believed to be usable in all or at least the vast majority of such devices, with moderate modifications which are within the skill of the art to provide.

Referring now to FIGS. 9 and 10, behind the light outlet window 114 is a shiny metal reflector 140 which reflects the light from the lamp and through the window 114.

At the center of the reflector 140 is an LED array 142. In this case, the LED array is one which requires 100 watts of power and produces white light with an intensity of approximately 8000 lumens. This is a very powerful light.

Referring particularly to FIG. 10, there is provided a heat-sink/fan cooling device 146. The device 146 consists of a conductive plate 152 from which extend a plurality of metallic fins 150 (also see FIG. 11) on opposite sides of a fan motor 148 with fan blades 149. Extending from the plate 150 is an extension structure 154, also thermally conductive, which is fastened to the support substrate of the LED array by electrically conductive glue.

The heat-sink and fan combination 146 preferably is one like those used for cooling computer video cards, such as the “Super Silent Professional Video Card Heat Pipe Cooler,” sold by Dealer Extreme (dealerextreme.com). It uses a 2500 rpm fan.

The blades 149 of the fan 148, like the blades of the fan used in the embodiment of FIGS. 1-5, are shaped with squared-off tips and are otherwise shaped to throw air outwardly laterally to flow in the spaces between the fins 150. The structure 146 has side-walls 153 and 155 which tend to guide air from the blades 149 towards the fins 150.

The structure 146 also has a heat-pipe structure 157 to increase its cooling capabilities. The heat pipe consists of a sealed copper tube with two central sections 159 and 161, which are somewhat flattened in the flat plane of the projection 154 to which the LED array 142 is secured to make good thermal contact with the surface to be cooled, and two end portions 163 and 165. The end portions 163 and 165 extend through holes in the fins 150 so as to transfer heat conducted from the LED array into the heat pipe into the fins 150 where the heat is removed by the fan 148.

Mounted on the outside of the housing 112, at the bottom thereof is a metal housing 134 secured to the bottom of the housing 112, which contains the power supply for the LED array and fan, and is connected to the LED and fan by conductors indicated at 138.

An alternative location for the power supply is inside the housing, at a location indicated by the reference numeral 135. Spacers attach the power supply to the heat sink, as in the FIGS. 1-5 embodiments. This location is preferred if there is sufficient room in the housing 112.

Electrical power is supplied to the circuitry in the housing 134 by means of a cord 136. Typically, this power will be either 120 volts or 230 volts AC. The AC voltage is converted to the necessary DC voltages required by the fan and LED array, as described herein above.

The housing 112 optionally has a plurality of holes 132 at opposite sides of the housing walls to serve as ventilation ports. These need not be provided if there are sufficient crevices or openings in the housing due to its natural construction to provide adequate egress for the cooling air developed by the fan 148.

If desired or necessary, the power supply can include a thermistor to shut off the power, or a light dimmer control circuit to cool off the LED array, should it overheat, due to failure of the fan, temporary occlusion of the air vent holes, or other abnormal causes.

It is believed that the structure shown for the work light provides more light than usually is available in work lights, and yet at a cost which is not prohibitively high. It is believed that the light output from the work lamp can be greater than that presently available for most work lamps, but without the excessive heating of the glass window, and without the short life of halogen bulbs when halogen lighting is used.

It is believed, as with other LED lamps disclosed herein, the life of the LED array can be as high as 50,000 hours or more.

### Automobile Headlights

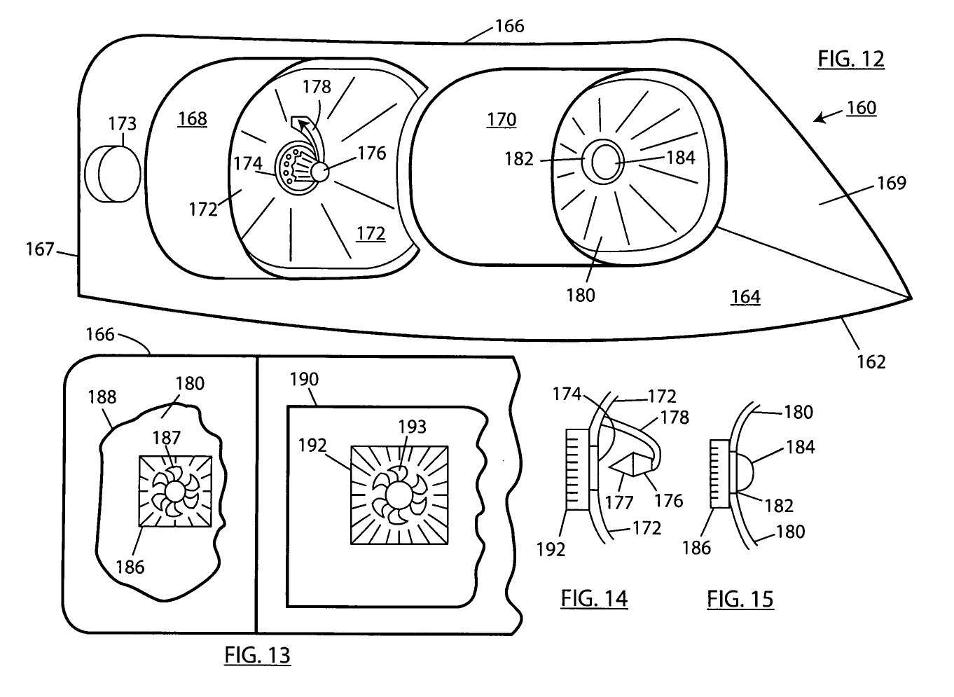

FIG. 12 is a perspective view of a headlight module 160 which fits into one of the right-receptacle if the front-end of a modern automobile. The particular unit shown forms the right side headlight module when viewing the automobile from the driver's seat, and there will be another module, a mirror-image of the module 160, at the left front corner of the vehicle.

In accordance with the present invention, the usual incandescent or halogen lamps have been replaced by LED lamps.

Module 160 comprises a body 166, usually molded of plastic materials, having a floor 164, side walls 165 and 167, and a transparent molded plastic window 162, which covers the entire front of the module 160 shown in FIG. 12 so light from two headlights 168 and 170 within the module can shine through and forwardly of the automobile to guide it.

The lamp 168 is the “high beam” or high intensity lamp, and the lamp 170 is the “low beam” headlamp. A turn signal lamp 173 also is present in the module.

The high beam lamp 168 includes a reflector 172 with a centrally-located circular LED array 174, and a central beam shaper 176 mounted on an arm 170 which is attached to the structure of the reflector 172.

As it is shown in FIG. 14, the beam shaper 176 has a conical-shaped forward end 178. The purpose of this is to shape the high beam properly.

The low-beam lamp 170 includes a reflector 180, a central circular LED array 182, and a convex lens 184 covering the LED array and shaping the light that it emits.

FIG. 13 is a partially broken-away and partially schematic rear view of the housing 166 with exit doors 188 and 190 open to show the heat sinks and the fans of the two LED lamps.

Through the opening 188, can be seen a heat sink 186 with a fan 187 as shown in FIGS. 1-5. The LED array 182 is attached to the heat sink in the same manner as the LED array is attached to the heat sink as shown in FIG. 1. Preferably, the light from the LED array 182 is not as bright as that from the other LEDs.

The LED array for the lamp 168. The lamp 168 has a larger heat sink 192 and fan 193, circular as shown above. As before, the heat sink is connected directly to the LED array in intimate heat conducting contact with it, to maximize heat transfer to the fins of the heat sink.

As in the work light of FIGS. 9-11, the heat-sink is located immediately behind the LED light source and behind the inner opening of the reflector at the center of the reflector.

The power supply or supplies for the lamps 168 and 170 are not shown because they are the same as those shown and described above for the other embodiments of the invention. There is ample room in the module 166 in which to mount the power supplies.

Although separate power supplies can be provided for each of the two headlamps, a single power supply could be used for both, if desired.

When the LED lamps shown in FIGS. 12-14 are used instead of halogen or incandescent lights, the electrical power used and, hence, the gasoline used to energize the headlamps is reduced, thus increasing gasoline mileage for the vehicle, and providing very bright light. Furthermore, the bulbs last for a very long time, probably longer than the car.

If desired, a battery back-up system, to be described below, can be provided for each of the headlights.

### Battery Back-Up

An optional feature of the invention is to provide battery back-up for operation of the automobile headlight and any of the other lamps described herein.

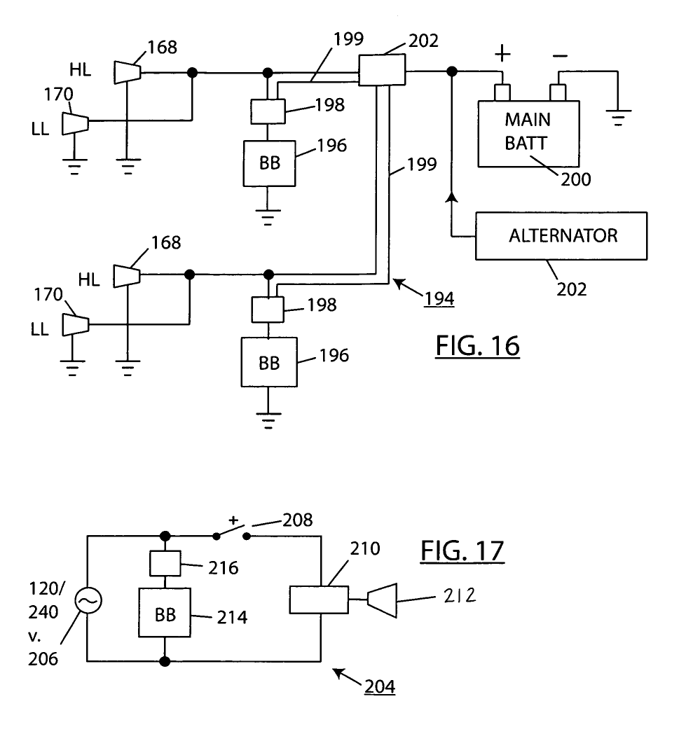

FIG. 16 is a schematic circuit diagram for a battery back-up circuit 194. FIG. 16 does not show the entire electrical circuit of an automobile, but only the part relevant to the feature here described.

The circuit includes the main battery 200 of the automobile, the alternator of the automobile, the light switching device 202 to switch the lights on and off, and to switch from dim to bright and bright to dim, etc. Both the high beam lamp 168 and the low beam 170 are connected to the switch 202. Connected between the headlamp and the switch 202 is a series combination of an electrical level sensing circuit 198 and a back-up rechargeable battery 196.

The back-up battery advantageously can consist of one or more low-voltage rechargeable batteries, such as those producing 4000 mAh protected lithium-ion rechargeable batteries. Any other batteries suitable to the task also can be used. Such batteries are relatively low-cost and can store adequate energy to continue the operations of the LED headlights 168 and 170 for up to an hour and a half or longer after the automobile battery 200 ceases to supply energy.

The device 198 senses the voltage supplied by the main battery 200. When that voltage drops below a predetermined level, such as when the battery dies and the alternator 202 is not running, and the light switch 202 is turned on, the device 198 forms an electrical connection of the back-up battery 196 to the lamps 168 and 170. The condition of the switch 202 is delivered to the devices 198 over lines 199.

Thus, if the headlights switch 202 is off, the back-up battery system will be inactive and will not light the headlights. However, if the switch 202 is on, and the voltage sensed by the device 198 is too low, the back-up battery is enabled to supply the relatively low power and voltage needed for the LED power supplies to continue enabling them to provide light. This can be very valuable in times of emergencies.

A similar circuit 204 is shown in FIG. 17 for providing battery back-up service for the other lamps described in this patent application which are supplied with AC voltage from a connection to the power grid 206 or other AC source.

A circuit 216 and a back-up battery unit 214 are connected in series. When the light switch 208 is closed, but the electrical power level falls below a predetermined minimum sensed by circuit 216, the back-up battery 214 is connected to supply energy to the power supply 210 for the LED lamp 212.

At all times, when the power supply is operating normally, the back-up battery 214 is recharged by the power supply 206.

Similarly, the back-up batteries 196 shown in FIG. 16 are recharged when the main battery 200 of the automobile is working normally.

### SPECIFICATIONS

The following LED arrays are typical examples of arrays which can be used:

20 Watt—white LED; brightness 1000 Lm

50 Watt—white LED; brightness 3500 Lm

100 Watt—white LED; brightness 8000 Lm

Following are the specifications of suitable fans and heat sinks:

Fan and heat-sink in FIGS. 1-5 and 12-15:

Snowflake DC Brushless Cooling fan for PC VideoCard

Fan and heat-sink in FIGS. 6-8:

3000 RPM Quiet CPU Fan (12V DC).

FIGS. 9-11:

“Super Silent Professional Video Card Heat Pipe Cooler” with 2500 RPM form, Part #41214, dealextreme.com

Other heat sink and fan combinations, preferably those used in personal computers, laptops, etc., can be used instead of those listed above.

The above description of the invention is intended to be illustrative and not limiting. Various changes or modifications in the embodiments described may occur to those skilled in the art. These can be made without departing from the spirit or scope of the invention.

1. An LED work lamp fixture comprising
a. a portable housing with an enclosure body having a carrying handle and a window through which light can shine from within said housing, and at least one air outlet opening in said enclosure body,
b. a support structure for supporting said enclosure body on a mounting surface, said support structure comprising legs extending horizontally and upwardly to support said enclosure body above a horizontal surface,
c. a reflector,
d. an LED lamp array mounted with respect to said reflector so that said reflector reflects light from said LED array out of said housing through said window,
e. a heat sink structure with fins and a flat heat-conducting surface, said LED lamp array being secured directly to said flat heat-conducting surface, with said heat sink mounted behind said reflector, and
f. a fan mounted closely adjacent said heat sink and positioned to force air sideways, parallel to said heat-conducting surface through said fins

2. A work lamp fixture as in claim 1 in which said air outlet opening is selected from the group consisting of at least one natural crevice in said enclosure body and at least one air hole cut in said enclosure body.

3. A work lamp fixture as in claim 1 in which said enclosure body is mounted on said support structure by means of a swivel structure which allows said enclosure body to be swiveled, and which has a hold feature to hold said body at a position to which it is swiveled.

4. A work lamp fixture as in claim 1 including a power supply mounted in one location selected from inside said enclosure body and secured to but spaced from said heat sink, and outside said body secured thereto, said power supply being adapted to receive AC power, convert it to DC power and supply said LED and said fan with appropriate voltage.

5. A work lamp fixture as in claim 1 in which said fan and heat sink are built for and used in computers, and said heat sink has a rectangular substrate with said fan mounted thereon and straight fins extending out of said substrate and located on opposite sides of said fan.

6. A work lamp fixture as in claim 12 in which said substrate has a conductive extension with a flat surface onto which said array is secured.

7. A fixture as in claim 1 in which said heat sink structure includes a heat pipe connected between said flat heat-conducting surface and said fins.

8. A fixture as in claim 1 including a back-up rechargeable battery normally connected for recharging from a power source to which said fixture is connected, and a detector to detect when voltage of said source drops below a predetermined level and connect said back-up battery to power said LED array when said voltage detected falls below said predetermined level.

9. An LED vehicle headlight fixture comprising
a. housing shaped to fit into a headlight receptacle in a vehicle,
b. said housing having a transparent forward wall forming a headlight window and a part of the body of said vehicle,
c. a reflector in said housing, positioned to beam light through said window,
d. an LED array mounted with respect to said reflector to cause light emitted by said array to be reflected out through said window,
e. a heat sink structure with fins and a flat heat-conducting surface, said LED lamp array being secured directly to said flat heat-conducting surface, and said heat sink being located behind said reflector, and
f. a fan mounted closely adjacent said heat sink and positioned to force air through said fins sideways, parallel to said flat heat-conducting surface.

10. A fixture as in claim 8 including a second LED array mounted in said housing and a second reflector for beaming light out through said window from said second array, and a second fan and heat sink assembly, coupled to said second LED array, one of said arrays having a lens for forming a focused beam of light and the other for forming a diffused light beam.

11. A fixture as in claim 8 including a battery back-up for said LED array, said back-up comprising at least one rechargeable battery, and a switching device for connecting said rechargeable battery to the main battery of an automobile when the charge on said main battery is above a predetermined level, and to connect said rechargeable battery to said LED array with said charge on said main battery is below said predetermined level and when the light on/off switch is turned on.

12. A fixture as in claim 8 in which said heat-sink and fan are made for and used in computers fit together with said fan mounted on a support wall of said heat sink with said fins extending outwardly away from said fan, and on opposite sides of said fan.

13. A fixture as in claim 9 in which one of LED arrays forms a high-beam lamp with a beam shaper mounted adjacent but spaced from said one LED array, and the other of said arrays forms a low-beam lamp with a diffusing lens, said LED arrays being circular.

14. A fixture as in claim 11 in which said heat-sink is circular with a vacant central area and said fins are radially-directed, with said fan mounted in said central area.
